(19) United States
(12) Patent Application Publication
(10) Pub. No.: US 2020/0278466 A1
(43) Pub. Date: Sep. 3, 2020

(54) Processing of Dispersive Waves in Acoustic Logging

(71) Applicant: Weatherford Technology Holdings, LLC, Houston, TX (US)

(72) Inventor: Yibing Zheng, Houston, TX (US)

(21) Appl. No.: 16/400,716

(22) Filed: May 1, 2019

Related U.S. Application Data
(60) Provisional application No. 62/811,986, filed on Feb. 28, 2019.

(51) Int. Cl. G01V 1/50; G01V 1/34; E21B 47/14

(52) U.S. Cl. CPC G01V 1/50; G01V 1/345; G01V 2210/47; G01V 2210/74; E21B 47/14

(57) ABSTRACT

Methods and systems for displaying sonic logging data are described herein. The displayed data includes highly reliable quality control (QC) indicators that can be used to identify any need for a dispersion correction. The disclosed data-driven approach determines whether a dispersion curve is asymptotic to the true formation shear slowness by calculating a coherence of the slowness at frequency intervals of the dispersion curve to indicate the level of the velocity dispersion. This coherence indicator can then be plotted against the averaged slowness within the frequency interval to show how well the asymptotic slowness is approached. The coherence indicator can be projected onto a slowness log as a QC indicator. A calculated formation shear slowness can be overlaid upon the slowness log.

### FIELD OF THE INVENTION

The present application relates to acoustic logging used in oil and gas operations, and more particularly, to dispersion asymptotic analysis for quality control (QC) for sonic processing of dispersive waves.

### BACKGROUND

Acoustic logging systems are routinely used in the oil and gas industry to measure formation acoustic properties of earth formation penetrated by a well borehole. These properties include the compressional and shear velocities of the formation, which are subsequently used to determine a variety of formation parameters of interest including, but not limited to; porosity, lithology, density and pore pressure. Acoustic logging data may be acquired using wireline tools and/or measuring while drilling (MWD) and/or logging while drilling (LWD) tools that include one or more acoustic transmitters to impart acoustic energy within the borehole and an array of acoustic receivers that detect acoustic waveforms within the borehole.

Acoustic logging is often undertaken to determine compressional and shear wave velocities of the formation. These velocities can subsequently be used to determine other parameters of interest, such as porosity, lithology, and pore pressure, all of which relate to the amount of oil or other hydrocarbons in the formation and/or the ease with which the hydrocarbons can be recovered. The velocities can be determined as a function of depth using techniques such as semblance processing, which is described in more detail below.

### SUMMARY

Disclosed herein is a method of displaying sonic logging data associated with an earth formation traversed by a borehole. According to some embodiments the method comprises: acquiring sonic data at a plurality of depths in the borehole using a receiver array, processing the acquired sonic data to generate a slowness-versus-depth log, processing the acquired sonic data at each of the plurality of depths to generate a dispersion plot of slowness-versus-frequency for each depth, determining an asymptotic index (A.I.), for each of the dispersion plots, wherein the A.I. indicates an extent to which the dispersion plot asymptotically approaches a formation slowness, projecting the determined AI s onto the slowness-depth log, and displaying the slowness-versus-depth log, wherein the projection of the A.I.s comprises a plurality of color bands corresponding to the determined. A.I.s. According to some embodiments, determining an A.I. for each of the dispersion plots comprises: segmenting the dispersion plot into a plurality of frequency windows, and for each frequency window, determining a mean slowness and a standard deviation of slowness values within the window. According to some embodiments, the asymptotic index A.I. is defined as:

$$A . I . = 1 - \frac{SD}{{S}_{m}}$$

where SD is the standard deviation of the slowness within the frequency window and Sₘ is the mean slowness within the frequency window. According to some embodiments, the formation slowness is a shear slowness, compressional slowness, or Stoneley slowness. According to some embodiments, determining an A.I. for each of the dispersion plots comprises: segmenting the dispersion plot into a plurality of frequency windows, and for each frequency window, determining a mean slowness, the maximum slowness, and the minimum slowness values within the frequency window. According to some embodiments, determining an A.I. for each of the dispersion plots comprises: segmenting the dispersion plot into a plurality of frequency windows, and for each frequency window, determining a mean slowness, a slowness value at a low-frequency edge of the window, and a slowness value at a high-frequency edge of the frequency window. According to some embodiments, determining an A.I. for each of the dispersion plots comprises: segmenting the dispersion plot into a plurality of frequency windows, and determining a sub-A.I. value for each frequency window, segmenting the dispersion plot into a plurality of slowness windows, and determining an A.I. value for each slowness windows by summing the sub-A.I. values within each of the plurality of slowness windows. According to some embodiments, determining a sub-A.I. value for each frequency window comprises: determining a mean slowness and a standard deviation of slowness values within the window. According to some embodiments, the sub-A.I. value is defined as:

$$subA . I . = 1 - \frac{SD}{{S}_{m}}$$

where SD is the standard deviation of the slowness within the frequency window and Sₘ is the mean slowness within the frequency window. According to some embodiments, the method further comprises determining a histogram of total sub-A.I. values as a function of slowness. According to some embodiments, the method further comprises determining a wave slowness of the formation at the plurality of depths, and overlaying a plot of the determined wave slowness on the displayed slowness-versus-depth log.

Also disclosed herein is a non-transitory computer readable medium comprising instructions, which, when executed on a computing device, configure the computing device to: access data comprising sonic data acquired at a plurality of depths in the borehole using a receiver array, process the acquired sonic data to generate a slowness-versus-depth log, process the acquired sonic data at each of the plurality of depths to generate a dispersion plot of slowness-versus-frequency for each depth, determine an asymptotic index (A.I.) for each of the dispersion plots, wherein the A.I. indicates an extent to which the dispersion plot asymptotically approaches formation slowness, project the determined A.I.s onto the slowness-depth log, and display the slowness-versus-depth log, wherein the projection of the A.I.s comprises a plurality of color bands corresponding to the determined A.I.s. According to some embodiments, determining an A.I. for each of the dispersion plots comprises: segmenting the dispersion plot into a plurality of frequency windows, and for each frequency window, determining a mean slowness and a standard deviation of slowness values within the window. According to some embodiments, the asymptotic index A.I. is defined as:

$$A . I . = 1 - \frac{SD}{{S}_{m}}$$

where SD is the standard deviation of the slowness within the frequency window and Sₘ is the mean slowness within the frequency window. According to some embodiments, the instructions further configure the computing device to: determine a wave slowness of the formation at the plurality of depths, and overlay a plot of the determined wave slowness on the displayed slowness-versus-depth log. According to some embodiments, the formation slowness is a shear slowness, compressional slowness, or Stoneley slowness.

Also disclosed herein is a system comprising: a receiver array deployable in a borehole traversing an earth formation, a computing device, and a non-transitory computer readable medium comprising instructions, which, when executed on a computing device, configure the computing device to: access sonic data acquired at a plurality of depths in the borehole using the receiver array, process the acquired sonic data to generate a slowness-versus-depth log, process the acquired sonic data at each of the plurality of depths to generate a dispersion plot of slowness-versus-frequency for each depth, determine an asymptotic index (A.I.) for each of the dispersion plots, wherein the A.I. indicates an extent to which the dispersion plot asymptotically approaches formation shear slowness, project the determined A.I.s onto the slowness-depth log, and display the slowness-versus-depth log, wherein the projection of the A.I.s comprises a plurality of color bands corresponding to the determined A.I.s. According to some embodiments, determining an A.I. for each of the dispersion plots comprises: segmenting the dispersion plot into a plurality of frequency windows, and for each frequency window, determining a mean slowness and a standard deviation of slowness values within the window. According to some embodiments, the asymptotic index A.I. is defined as:

$$A . I . = 1 - \frac{SD}{{S}_{m}}$$

where SD is the standard deviation of the slowness within the frequency window and Sₘ is the mean slowness within the frequency window. According to some embodiments, the formation slowness is a shear slowness, compressional slowness, or Stoneley slowness.

### BRIEF DESCRIPTION OF THE DRAWINGS

FIG. 1 shows an acoustic logging tool.

FIG. 2 shows acoustic signals detected using an acoustic logging tool.

FIG. 3 show a semblance map.

FIGS. 4A and 4B show examples of dispersion curves.

FIG. 5 shows an embodiment of processing a dispersion curve.

FIG. 6 shows asymptotic index (A.I.) plotted as a function of slowness.

FIG. 7 shows a log of asymptotic index (A.I.) with formation shear slowness overlaid on the log.

FIGS. 8A and 8B show an alternative embodiment of processing a dispersion curve and a histogram of total A.I. counts at a range of slowness values.

FIG. 9 shows a workflow for generating and displaying sonic logging data.

### DESCRIPTION

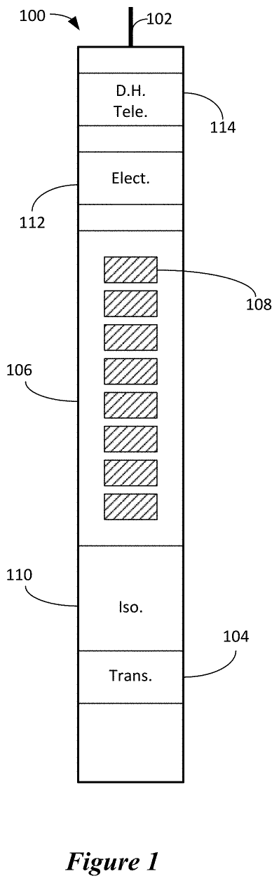

FIG. 1 illustrates aspects of a wireline-deployable acoustic logging tool 100 for obtaining acoustic measurements in a borehole. It should be noted that, while a wireline-deployable tool is illustrated, similar acoustic logging tools may be incorporated into a drill string for LWD/MWD applications. The illustrated acoustic logging tool 100 may be deployed into a borehole using a line 102, which may be a wireline, slickline, coiled tubing, or the like. The acoustic logging tool includes a transmitter section 104 and a receiver assembly 106 The transmitter section may contain one or more acoustic transmitters that can impart acoustic signals to the environment. According to some embodiments, the transmitters preferentially excite one or more acoustic modes including but not limited to compressional, dipole and Stoneley modes, The receiver assembly 106 includes a plurality of receivers 108 axially spaced from the transmitter 104. Eight receivers 108 are illustrated for purposes of discussion, although more or fewer receivers can be used. The receivers 108 are shown axially aligned, although axial alignment is not required if the transmitter firing sequence is suitably adjusted. According to some embodiments, an isolator section 110 may separate the transmitter section 104 and the receiver assembly 106.

The acoustic logging tool 100 also includes an electronics section 112. The electronics section may include one or more processors that are configured to receive and process signals from the receivers 108. The electronics section may include a memory configured to record waveform data obtained from the receivers 108. The processor(s) also controls, among other things, the firing of the transmitter(s). The electronics section 112 may be operably connected to a downhole telemetry unit 114. Data from elements within the acoustic logging tool 100, whether processed downhole as parameters of interest or in the form of “raw” data, can be telemetered to the surface of the earth by means of a suitable telemetry system. For example, the data can be telemetered via the line 102. In embodiments of LVD/MWD applications, the data can be telemetered using mud pulse, acoustic, etc., as known in the art. The telemetered data are received by an up-hole telemetry element (not shown). The data can also be stored inside the tool while it is downhole, and can be retrieved for further processing later. For example, embodiments of the tool may be configured with memory which stores the high-fidelity data so as to avoid the high bandwidth needed to telemeter data to surface.

Embodiments of the acoustic logging tool 100 may be conveyed into a borehole using various conveyance methods. For example, the illustrated embodiment is an example of a tool configured to be conveyed into a wellbore via a cable, such as line 102. However, other embodiments may be included as a part or subsection of other conveyed components, for example, as part of a drilling string for LWD/MWD applications. Moreover, although shown embodied in a wireline logging tool, the tool can also be embodied in other borehole instruments. These instruments include pump-down (“memory”) instruments conveyed by drilling fluid flow, instruments conveyed by coiled tubing, instruments conveyed by a drill string, and instruments conveyed by a “slick line”.

As the acoustic logging tool 100 is conveyed along a borehole, either using the line 102, or by a drill string or any other conveyance method, one or more parameter of interest, or alternately raw data, are recorded as a function of depth (or, in some embodiments, recorded as a function of time, which correlates to depth via the logging rate). The recorder output is typically a “log” of the data as a function of time or borehole depth. The data can additionally/alternately be recorded in down-hole processor memory, and subsequently downloaded to a surface equipment module when the tool 100 is returned to the surface during or after the logging operation is completed. The downloaded data are typically processed further at the surface to obtain additional parameters of interest that cannot be determined in the down-hole processor unit.

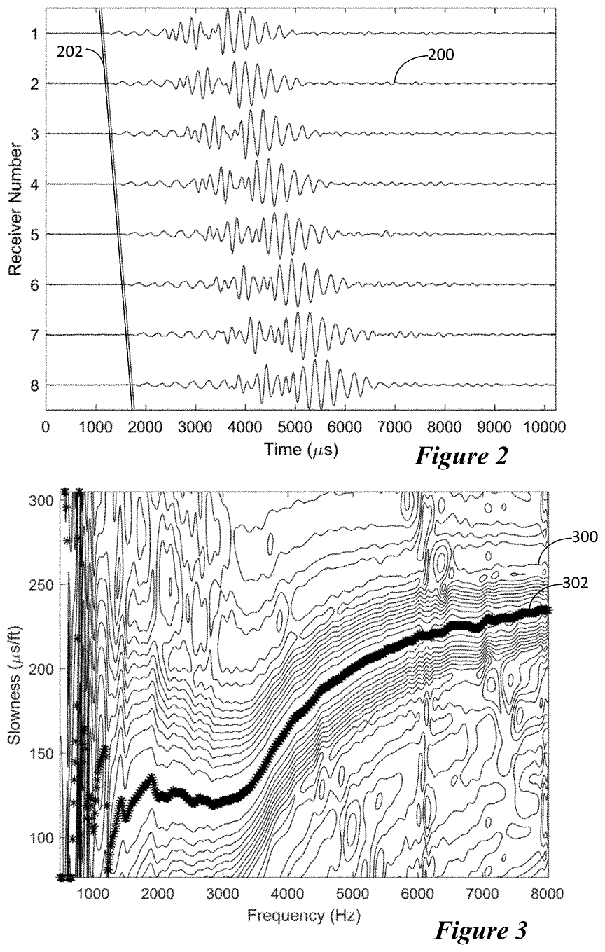

FIG. 2 illustrates acoustic signals 200 received by the plurality of receivers 108. Each acoustic signal is a plot of amplitude (in arbitrary units) versus time. The uppermost signal (signal 1) corresponds to the signal from the receiver 108 nearest transmitter section 104, with the next lower signal (signal 2) corresponding to the next nearest receiver, etc. As can be seen, the receivers located farther from the transmitter will experience signal arrival at a later time.

When the sonic waves inside a borehole are dispersive, that is, the speed of the sonic energy varies with frequency, with low frequencies travelling faster through the borehole than high frequency, the sonic energy is “smeared out” as it travels through the borehole. FIG. 2 illustrates the waveforms from a wireline dipole excitation. The line 202 of FIG. 2 shows the leading edge of sonic signal received at each of the receiver. Ideally, the line 202 would correspond to the true shear velocity of the formation within the borehole.

Slowness-frequency analysis (such as frequency-domain semblance methods) can be applied to acoustic signals like signals 200 illustrated in FIG. 2 to generate a slowness-frequency coherence map like that illustrated in FIG. 3, which is generated by the frequency-domain semblance method. The coherence map has been conceptualized for brevity and comprises a plot of slowness (ordinate) as a function of frequency from the wave field responses recorded by the receivers 108 shown in FIG. 1. Slowness and frequency are expressed in units of microseconds per foot (μs/ft) and Hertz (Hz), respectively. Contours 300 indicate values of increasing magnitude of coherence (i.e., semblance). In practice, coherence maps are typically depicted in color. For example, low coherence values might be depicted in blue to green shades, with intermediate coherence values depicted by yellow shades, with the highest coherence values depicted by orange to red shades. A dispersion curve 302 can be extracted by finding peak coherence values at each frequency in the coherence map. Ideally, the dispersion curve 302 can be used to determine the shear velocity (or its inverse, namely shear slowness) of the rock formation through which the borehole has been drilled. It should be noted that, while the particular examples considered in this disclosure primarily relate to formation shear slowness, the techniques and methods described herein are also applicable to other formation slowness measurements, such as compressional slowness, Stoneley slowness, and the like. Likewise, the techniques and methods are applicable to logging with any of a monopole, dipole, quadrupole, or even higher order acoustic logging mode.

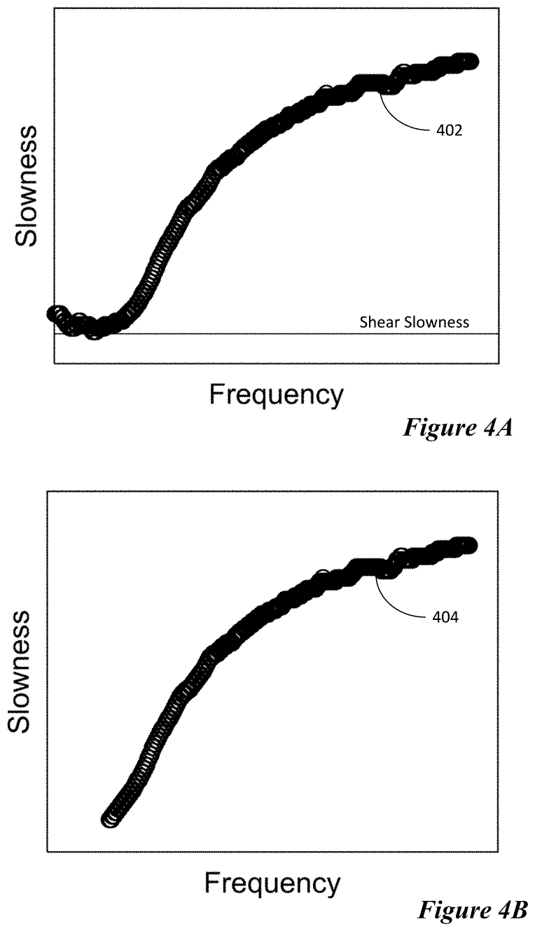

FIGS. 4A and 4B illustrate two different dispersion curves for dipole acoustic waves, similar to the dispersion curve 302 obtained from the coherence map of FIG. 3. The slowness of the acoustic wave is a function of frequency, indicating that the acoustic waves are dispersive, as described above. Generally, dipole waves (a.k.a, flexural waves), quadrupole waves (a.k.a., screw waves), leaky P waves, and refracted shear waves (a.k.a., pseudo Rayleigh waves) display dispersive behavior. Referring to FIG. 4A, the dispersion curve 402 of the dipole acoustic data becomes asymptotic to the formation shear slowness at low frequency. Thus, the asymptotic behavior of the dispersion curve 402 provides an indication of the shear slowness of the formation. Referring to FIG. 4B, notice that the dispersion curve 404 lacks the low frequency components that become asymptotic. Thus, the true shear slowness of the formation would likely be smaller than a shear slowness calculated based on the dispersion curve 404.

This disclosure presents a new and robust method for evaluating the output from acoustic well log waveform processing by analyzing the asymptotic behavior of dispersion curves. It is a data-driven approach which helps improve the accuracy of formation slowness measurement and identifies any need for a correction to the measured slowness value, such as a model-based dispersion correction, as is known in the art. In acoustic well logging many of the waves propagating inside the borehole are dispersive, such as wireline dipole and LWD quadrupole waves for the determination of formation shear slowness, and leaky P wave for compressional slowness in soft formations. Only at low frequency does the speed of these waves approach the true formation value, the wave speed being slower at higher frequencies. Slowness processing can therefore be influenced by strong high frequency waves, resulting in measured slowness values greater than the true formation values. The new method determines whether a dispersion curve is asymptotic to the true formation by calculating the coherence of the slowness at each frequency interval of the dispersion curve to indicate the level of the velocity dispersion. This coherence indicator is then plotted against the averaged slowness within the frequency interval to show how well the asymptotic slowness is approached. The method has been applied to wireline acoustic logging dipole waves in wells with both hard and soft formations, as well as to leaky-p waves in soft formations. Results show that the method not only identifies the fastest waves in the data but also identifies where additional model-based dispersion corrections are needed. When the waveform's dispersion curve has a smooth approach to its true formation slowness, the asymptotic analysis shows a high value of coherence at that slowness indicting high confidence in the measured slowness. On the other hand, when the dispersion curve lacks the low frequency asymptotic part, the analysis's low-value indicator suggests that a correction to the measured slowness is necessary. The indicator generated by this novel method allows the quality of the formation slowness measurement to be assessed. Traditional data-driven dispersive QC methods can identify if the processed slowness is the smallest (which means fastest) within the available wave energy, but does not assess the result's accuracy when the asymptotic part of the dispersion is missing due to lack of low frequency energy. However, the disclosed method achieves both of these two objectives in a simple and clear way.

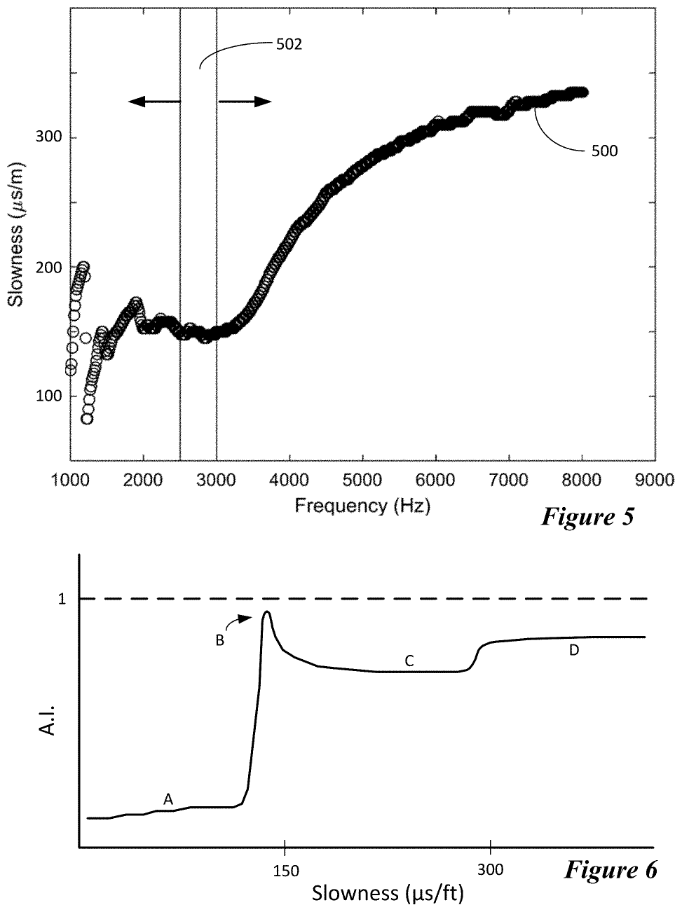

The disclosed method involves determining a statistical analysis projection based on the dispersion curves. The statistical analysis projection provides an indicator of whether the dispersion curve displays the low frequency asymptotic behavior indicating the true formation shear slowness. One example of a statistical measure used in the analysis is standard deviation. FIG. 5 illustrates a dispersion curve 500. To perform the statistical analysis, a window 502 is defined which spans a frequency range for part of the curve. In the illustrated example, the window 502 has a width of 500 Hz. However, other window widths can be used, for example 200 Hz, 400 Hz, 600 Hz, 800 Hz or 1000 Hz, etc. Within the window, the mean slowness and the standard deviation of the slowness is determined. It will be appreciated that a low standard deviation indicates that the slowness does not vary greatly throughout the window. In other words, a low standard deviation indicates that the dispersion curve is flat and is, therefore, likely at or approaching asymptotic behavior. Likewise, a high standard deviation indicates that the curve has a substantial slope within the window. The mean slowness and standard deviation are determined within the window 502 for a consecutive sequence window positions with progressively higher frequency values.

The statistical analysis (e.g., mean slowness and standard deviation) can be used to derive an asymptotic index (A.I.). According to one embodiment, the asymptotic index A.I. is defined as:

$$A . I . = 1 - \frac{SD}{{S}_{m}} \qquad ( 1 )$$

where SD is the standard deviation of the slowness within the window and Sₘ is the mean slowness within the window. The highest value of the A.I. is 1, which indicates that the dispersion curve within the frequency window is perfectly flat.

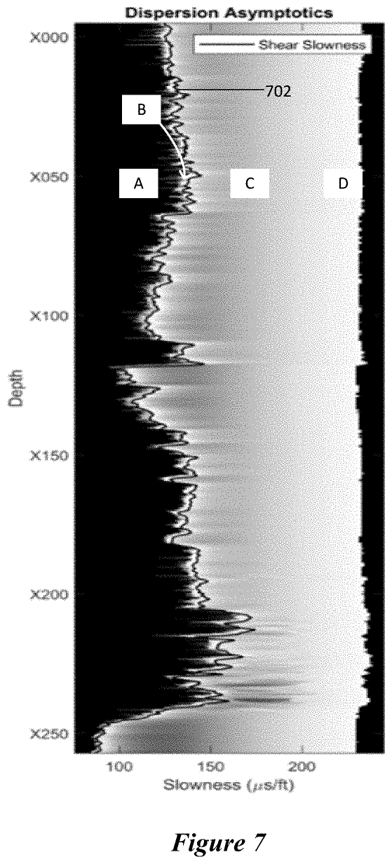

FIG. 6 illustrates a sequence of asymptotic index A.I. values plotted against slowness, such as derived from a plot as shown in FIG. 5. As seen in the plot of FIG. 6, the slowness values around 150 μs/ft exhibit a high A.I. value, reflected as a “lip” in the plot. This is because the dispersion plot 500 shown in FIG. 5 displays asymptotic behavior at that slowness. Plots, such as illustrated in FIG. 6 can be determined/calculated at each measurement depth and the A.I. values at each slowness can be color coded and projected to a slowness axis to form a log showing the variation in A.I. as a function of depth in a wellbore. FIG. 7 illustrates an example of such an asymptotic index log. In the log illustrated in FIG. 7, bright colors correspond to high A.I. and darker colors correspond to low A.I. The regions of the A.I./slowness plot of FIG. 6 are correlated to the grey-scale regions of the log illustrated in FIG. 7 for comparison. Note that the “lip” indicating high A.I. at a slowness of about 150 μs/ft shown as B in the plot of FIG. 6 is reflected as a thin strip of bright coloration B separating the black region A and the grey region C in the log illustrated in FIG. 7, It will be appreciated that logs used in practice would typically be color coded, for example using bright yellow to indicate high A.I, blue to indicate low A.I., and green and yellow to indicate medium A.I. The log illustrated in FIG. 7 also indicates the calculated shear slowness curve 702 of the formation, which was calculated using time semblance. Notice that the shear slowness curve lies on the left edge of the asymptotic index log and within the bright area B indicating high asymptotic index. That indicates that the slowness curve represents a reliable result.

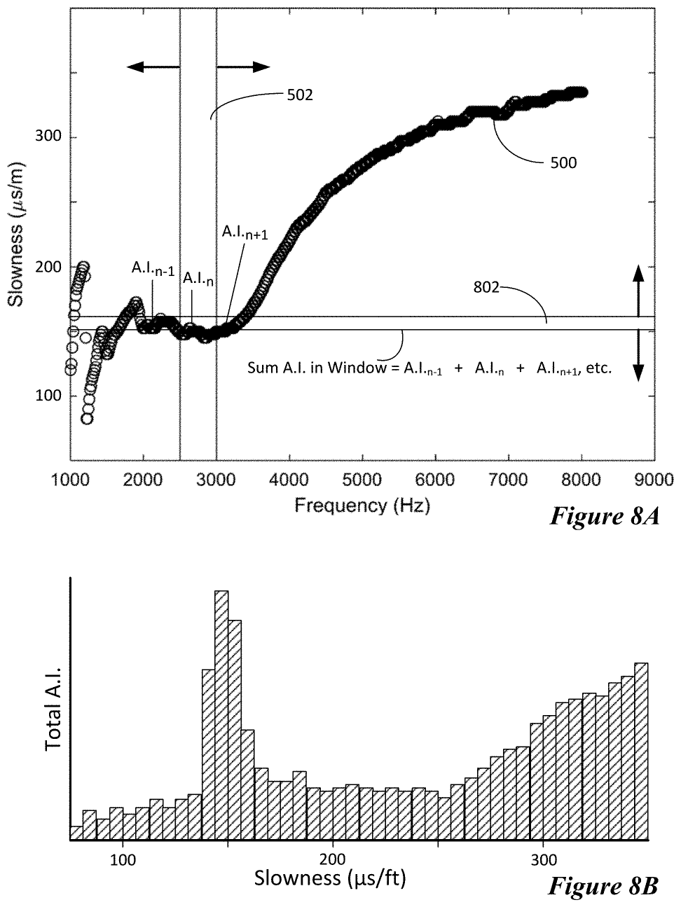

Referring again to FIG. 5, as mentioned above, the disclosed method involves determining a statistical analysis of the dispersion curve 500 within the window 502 to determine the flatness of the curve. Standard deviation was used as the statistical analysis in the discussion above. However, other methods of determining flatness (i.e., asymptotic behavior) can be used. For example, simple differences can be used. For example, the mean slowness within the window can be determined and the simple differences between the slowness values at the left and right edges of the window 502 can provide an indication of flatness, Alternatively, a simple difference between the highest frequency value and the lowest frequency value within the window can be used. Still alternatively, a histogram relating the total of the A.I. values (i.e., a total A.I. value calculated as a sum of sub-A.I. values) within a range of slowness values can be used, as illustrated in FIGS. 8A and 8B. Referring to FIG. 8A, a window 802 defining a range of slowness values can be defined for the dispersion curve 500. First, sub-A.I.s are calculated for the dispersion curve using windows 502 along the frequency axis, as described above. For example, equation (1) above can be used to calculate the sub-A.I.s for each frequency window, This calculation yields a number of sub-A.I. values A.I.ₙ₋₁, A.I.ₙ, A.I.ₙ₊₁, etc. Then, the sum of the calculated sub-A.I. values within the slowness window 802 can be tabulated. As the slowness window 802 is slid along the slowness axis the summed sub-A.I. values within each slowness window location can be expressed as a histogram, as illustrated in FIG. 8B. Referring to FIG. 8B, note that the high sum of A.I. values corresponding to slowness values of about 150 μs/ft indicates the asymptotic behavior of the dispersion curve 500. The histogram, as illustrated in FIG. 8B, can be color-coded and presented as a log, similar to the log illustrated in FIG. 7.

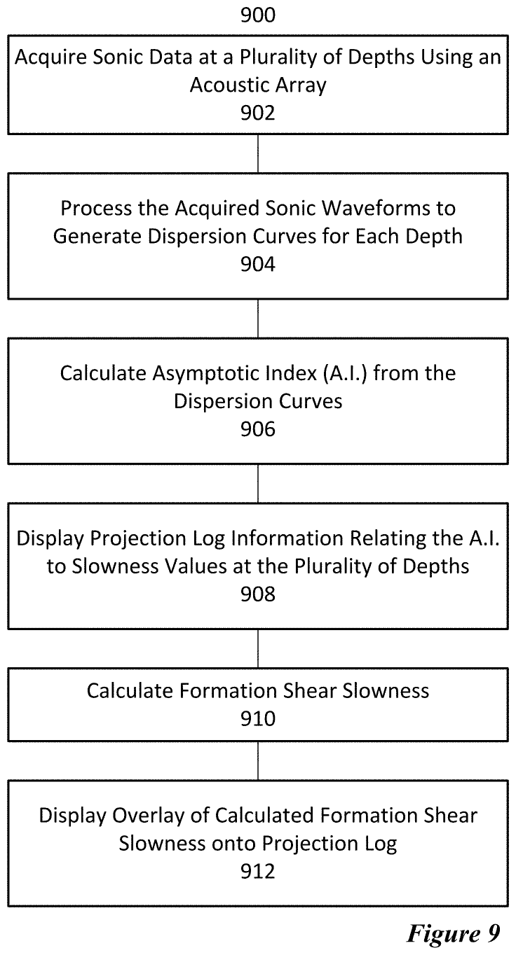

A person of skill in the art will appreciate that the techniques described above can provide techniques for acquiring and displaying sonic logging data that provide highly reliable, visual quality-control (QC) indicators. The QC indicators correspond to the determined statistical analysis (i.e., the asymptotic indices) of the dispersion curves obtained at the depths of interest. FIG. 9 provides an overview of an embodiment of a workflow 900 utilizing the described techniques. Sonic data is acquired at a plurality of depths in the borehole using an acoustic array 902 (see FIG. 1), The acquired sonic waveforms are processed to generate dispersion curves 904 at each depth (see FIGS. 2 and 3). Statistical analysis of the dispersion curves, as described above, is used to determine asymptotic indices (A.I.), which indicate if the dispersion curves asymptotically approach the true formation slowness 906. The A.I. values provide a coherence indicator showing how well asymptotic slowness is approached. The A.I. values can be projected against the slowness values and the projection information can be plotted as a log 908 at the plurality of depths. The projection log provides a QC indicator indicating either high confidence in the measured slowness or suggesting that additional model-based correction to the measured slowness is needed. The formation shear slowness can be calculated 910, for example using time-semblance methods. The calculated formation shear slowness can be overlaid onto the projection log 912, providing a visual indicator of the shear slowness simultaneously with its reliability.

It should be noted that the above discussion focuses primarily on diploe acoustic waves. However, it should be noted that the methods and techniques described above can generally he applied to any dispersive acoustic waves, such as quadrupole waves, leaky P waves, and/or refracted shear waves.

Some portions of the detailed description were presented in terms of processes, programs and workflows. These processes, programs and workflows are the means used by those skilled in the data processing arts to most effectively convey the substance of their work to others skilled in the art. A process or workflow is here, and generally, conceived to be a self-consistent sequence of steps (instructions) contained in memory and run or processing resources to achieve a desired result. The steps are those requiring physical manipulations of physical quantities. Usually, though not necessarily, these quantities take the form of electrical, magnetic or optical signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “receiving,” “calculating.” “determining,” “displaying,” or the like, refer to the action and processes of a computer system, or similar electronic computing device, that manipulates and transforms data represented as physical (electronic) quantities within the computer system memories or registers or other such information storage, transmission or display devices.

The present invention also relates to an apparatus for performing the operations herein. This apparatus may be specially constructed for the required purposes, or it may comprise a general-purpose computer, selectively activated or reconfigured by a computer program stored in the computer. Such a computer program may be stored in a non-transitory computer readable storage medium, which could be, but is not limited to, any type of disk including floppy disks, optical disks, CD-ROMs, an magnetic-optical disks, read-only memories (ROMs), random access memories (RAMs), EPROMs, EEPROMs, magnetic or optical cards, application specific integrated circuits (ARCO, or any type of media. suitable for storing electronic instructions, and each coupled to a computer system bus. Furthermore, the computers referred to in the specification may include a single processor, or may be architectures employing multiple processor designs for increased computing capability.

While the invention herein disclosed has been described in terms of specific embodiments and applications thereof, numerous modifications and variations could be made thereto by those skilled in the art without departing from the scope of the invention set forth in the claims.

What is claimed is:

1. A method of displaying sonic logging data associated with an earth formation traversed by a borehole, the method comprising:
acquiring sonic data at a plurality of depths in the borehole using a receiver array,
processing the acquired sonic data to generate a slowness-versus-depth log,
processing the acquired sonic data at each of the plurality of depths to generate a dispersion plot of slowness-versus-frequency for each depth,
determining an asymptotic index (A.I.) for each of the dispersion plots, wherein the A.I. indicates an extent to which the dispersion plot asymptotically approaches a formation slowness,
projecting the determined A.I.s onto the slowness-depth log, and
displaying the slowness-versus-depth log, wherein the projection of the A.I.s comprises a plurality of color bands corresponding to the determined A.I.s.

2. The method of claim 1, wherein determining an A.I. for each of the dispersion plots comprises:
segmenting the dispersion plot into a plurality of frequency windows, and
for each frequency window, determining a mean slowness and a standard deviation of slowness values within the window.

3. The method of claim 2, wherein the asymptotic index A.I. is defined as:
$$A . I . = 1 - \frac{SD}{{S}_{m}}$$
where SD is the standard deviation of the slowness within the frequency window and Sₘ is the mean slowness within the frequency window.

4. The method of claim 1, wherein the formation slowness is a shear slowness, compressional slowness, or Stoneley slowness.

5. The method of claim 1, wherein determining an A.I. for each of the dispersion plots comprises:
segmenting the dispersion plot into a plurality of frequency windows, and
for each frequency window, determining a mean slowness, the maximum slowness, and the minimum slowness values within the frequency window.

6. The method of claim 1, wherein determining an A.I. for each of the dispersion plots comprises:
segmenting the dispersion plot into a plurality of frequency windows, and
for each frequency window, determining a mean slowness, a slowness value at a low-frequency edge of the window, and a slowness value at a high-frequency edge of the frequency window.

7. The method of claim 1, wherein determining an A.I. for each of the dispersion plots comprises:
segmenting the dispersion plot into a plurality of frequency windows, and
determining a sub-A.I. value for each frequency window,
segmenting the dispersion plot into a plurality of slowness windows, and
determining an A.I. value for each slowness windows by summing the sub-A.I. values within each of the plurality of slowness windows.

8. The method of claim 7, wherein determining a sub-A.I. value for each frequency window comprises: determining a mean slowness and a standard deviation of slowness values within the window.

9. The method of claim 8, wherein the sub-A.I. value is defined as:
$$subA . I . = 1 - \frac{SD}{{S}_{m}}$$
where SD is the standard deviation of the slowness within the frequency window and Sₘ is the mean slowness within the frequency window.

10. The method of claim 7, further comprising determining a histogram of total sub-A.I. values as a function of slowness.

11. The method of claim 1, further comprising:
determining a wave slowness of the formation at the plurality of depths, and overlaying a plot of the determined wave slowness on the displayed slowness-versus-depth log.

12. A non-transitory computer readable medium comprising instructions, which, when executed on a computing device, configure the computing device to:
access data comprising sonic data acquired at a plurality of depths in the borehole using a receiver array,
process the acquired sonic data to generate a slowness-versus-depth log,
process the acquired sonic data at each of the plurality of depths to generate a dispersion plot of slowness-versus-frequency for each depth,
determine an asymptotic index (A.I.) for each of the dispersion plots, wherein the A.I. indicates an extent to which the dispersion plot asymptotically approaches formation slowness,
project the determined A.I.s onto the slowness-depth log, and
display the slowness-versus-depth log, wherein the projection of the A.I.s comprises a plurality of color bands corresponding to the determined A.I.s.

13. The non-transitory computer readable medium of claim 12, wherein determining an A.I. for each of the dispersion plots comprises:
segmenting the dispersion plot into a plurality of frequency windows, and
for each frequency window, determining a mean slowness and a standard deviation of slowness values within the window.

14. The non-transitory computer readable medium of claim 13, wherein the asymptotic index A.I. is defined as:
$$A . I . = 1 - \frac{SD}{{S}_{m}}$$
where SD is the standard deviation of the slowness within the frequency window and Sₘ is the mean slowness within the frequency window.

15. The non-transitory computer readable medium of claim 12, wherein the instructions further configure the computing device to:
determine a wave slowness of the formation at the plurality of depths, and
overlay a plot of the determined wave slowness on the displayed slowness-versus-depth log.

16. The non-transitory computer readable medium of claim 12, wherein the formation slowness is a shear slowness, compressional slowness, or Stoneley slowness.

17. A system comprising:
a receiver array deployable in a borehole traversing an earth formation,
a computing device, and
a non-transitory computer readable medium comprising instructions, which, when executed on a computing device, configure the computing device to:
access sonic data acquired at a plurality of depths in the borehole using the receiver array,
process the acquired sonic data to generate a slowness-versus-depth log,
process the acquired sonic data at each of the plurality of depths to generate a dispersion plot of slowness-versus-frequency for each depth,
determine an asymptotic index (A.I.) for each of the dispersion plots, wherein the A.I. indicates an extent to which the dispersion plot asymptotically approaches formation shear slowness,
project the determined A.I.s onto the slowness-depth log, and
display the slowness-versus-depth log, wherein the projection of the A.I.s comprises a plurality of color bands corresponding to the determined A.I.s.

18. The system of claim 17, wherein determining an A.I. for each of the dispersion plots comprises:
segmenting the dispersion plot into a plurality of frequency windows, and
for each frequency window, determining a mean slowness and a standard deviation of slowness values within the window.

19. The system of claim 18, wherein the asymptotic index A.I. is defined as:
$$A . I . = 1 - \frac{SD}{{S}_{m}}$$
where SD is the standard deviation of the slowness within the frequency window and Sₘ is the mean slowness within the frequency window.

20. The system of claim 17, wherein the formation slowness is a shear slowness, compressional slowness, or Stoneley slowness.
